(19) United States
(12) Patent Application Publication
(10) Pub. No.: US 2023/0359217 A1
(43) Pub. Date: Nov. 9, 2023

(54) OPTICAL NAVIGATION DEVICE WHICH CAN DETECT AND RECORD ABNORMAL REGION

(71) Applicant: PixArt Imaging Inc., Hsin-chu city (TW)

(72) Inventors: Ning Shyu, Hsin-Chu City (TW); Han-Lin Chiang, Hsin-Chu City (TW)

(73) Assignee: PixArt Imaging Inc., Hsin-Chu City (TW)

(21) Appl. No.: 17/737,975

(22) Filed: May 5, 2022

(51) Int. Cl. G05D 1/02; G06V 10/56; G06T 7/90; A47L 11/24; A47L 11/40

(52) U.S. Cl. CPC G05D 1/0246; G06V 10/56; G06T 7/90; A47L 11/24; A47L 11/4011; A47L 11/4002; G05D 2201/0203; A47L 2201/04

(57) ABSTRACT

An optical navigation device, comprising: at least one image sensor, configured to sense at least one sensing image; and a processing circuit, configured to determine at least one abnormal region in the sensing image and control the optical navigation device to inform the abnormal region exists to a user.

### BACKGROUND OF THE INVENTION

### 1. Field of the Invention

The present invention relates an optical navigation device, and particularly relates to an optical device which can detect abnormal regions.

### 2. Description of the Prior Art

In recent years, automatic sweepers such as robot cleaners become more and more popular. However, a conventional automatic sweeper only has the function of cleaning but does not have the function of detecting abnormal regions. Therefore, the user still needs other methods to find the abnormal regions. For example, the user needs to get down for checking if the floor under furniture damages or any junk is under the furniture. Also, the unexpected objects such as a tiny toy or a plastic bag may be inhaled into the automatic sweeper, thus the automatic sweeper may be jammed or even malfunction due to the unexpected objects.

### SUMMARY OF THE INVENTION

One embodiment of the present invention discloses an optical navigation device, comprising: at least one image sensor, configured to sense at least one sensing image; and a processing circuit, configured to determine at least one abnormal region in the sensing image and control the optical navigation device to inform the abnormal region exists to a user.

Another embodiment of the present invention discloses an optical navigation device, comprising: a first image sensor, configured to generate first sensing images, wherein a first angle exists between a sensing direction of a sensing surface of the first image sensor and the surface, wherein the first angle is a smallest angle among angles exist between the sensing direction of the first image sensor and the surface; a second image sensor, configured to generate second sensing images, wherein a second angle exists between a sensing direction of a sensing surface of the second image sensor and the surface, wherein the second angle is a smallest angle among angles exist between the sensing direction of the second image sensor and the surface, wherein the first angle is larger than the second angle; and a processing circuit, configured to determine and record at least one abnormal region according to the second sensing images of and then according to the first sensing images.

Another embodiment of the present invention discloses: a robot, comprising: a housing, having at least two wheels and configured to move on a working surface; at least one image sensor, disposed in the housing and configured to sense at least one sensing image; and a processing circuit, disposed in the housing and configured to determine at least one abnormal region in the sensing image and control the robot to inform a user with the abnormal region.

In view of above-mentioned embodiments, the automatic sweeper can detect abnormal regions, thus the user does not need to check the state of the floor under furniture by his self. Besides, the automatic sweeper can avoid to be damaged due to the unexpected objects on the floor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an automatic sweeper according to one embodiment of the present invention.

FIG. 2, FIG. 3 and FIG. 4 are schematic diagrams illustrating how the abnormal regions are determined, according to different embodiments of the present invention.

FIG. 5 is a schematic diagram illustrating how the protruding level is computed, according to one embodiment of the present invention.

FIG. 6 is a schematic diagram illustrating a sensing image comprising regions which protrude from a surface.

FIG. 7 is a schematic diagram illustrating an automatic sweeper according to another embodiment of the present invention.

FIG. 8 is a flow chart illustrating detail operations of the automatic sweeper according to one embodiment of the present invention.

### DETAILED DESCRIPTION

Several embodiments are provided in following descriptions to explain the concept of the present invention. Each component in following descriptions can be implemented by hardware (e.g. a device or a circuit) or hardware with software (e.g. a program installed to a processor). Additionally, the term “first”, “second”, “third” in following descriptions are only for the purpose of distinguishing different one elements, and do not mean the sequence of the elements. For example, a first device and a second device only mean these devices can have the same structure but are different devices.

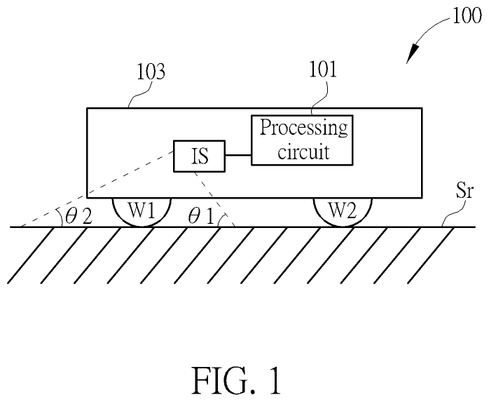

FIG. 1 is a schematic diagram illustrating an automatic sweeper according to one embodiment of the present invention. In FIG. 1, the automatic sweeper 100 is provided on a surface Sr (e.g., a floor). As illustrated in FIG. 1, the automatic sweeper 100 comprises a processing circuit 101 and an image sensor IS. The image sensor IS is configured to sense at least one sensing image. Also, the processing circuit 101 is configured to determine and record at least one abnormal region in the sensing image. Please note the abnormal region mentioned here can mean a region corresponding to a portion in a sensing image or a region corresponding to a plurality of sensing images. The image sensor IS has a sensing surface which can receive light and generates sensing images according to the light. In one embodiment, the automatic sweeper 100 can further comprise a light source to emit light, and the image sensor IS receives the reflected light of light from the light source to generate sensing images. However, the image sensor IS can sense ambient light or light from an external light source to generate sensing images.

The sensing direction, which can be a normal factor of the sensing surface, can be set corresponding to different requirements. For example, the sensing direction (the dotted line) of the image sensor IS can be set to be lower, such that a first angle θ1 exists between the sensing direction and the surface Sr. The first angle θ1 is a smallest angle between angles existing between the sensing direction of the image sensor IS and the surface Sr. For another example, the sensing direction of the image sensor IS can be set to be more forward, such that a second angle θ2 exists between the sensing direction and the surface Sr. The second angle θ2 is a smallest angle between angles existing between the sensing direction and the surface Sr. The first angle θ1 is larger than the second angle θ2.

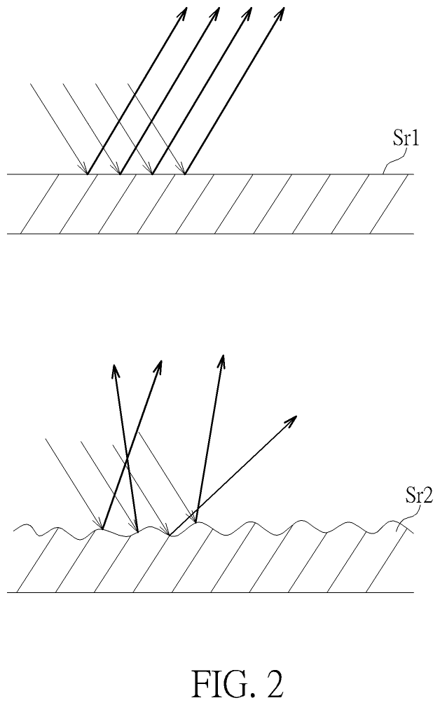

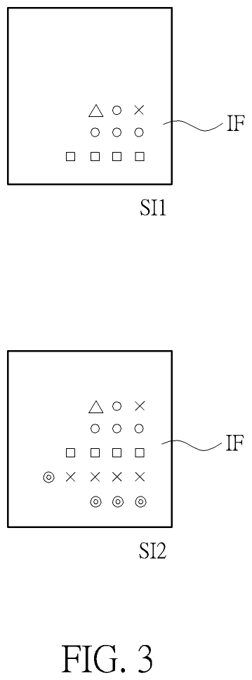

The abnormal regions can be detected by various methods. FIG. 2, FIG. 3 and FIG. 4 are schematic diagrams illustrating how the abnormal regions are determined, according to different embodiments of the present invention. As shown in FIG. 2, the light scattering level of light varies corresponding to different surfaces Sr1, Sr2. Specifically, the surface Sr1 is more flat, thus the light scattering level of light emitted to the surface Sr1 is smaller. On the opposite, the surface Sr2 is more uneven, thus the light scattering level of light emitted to the surface Sr2 is larger. Therefore, the processing circuit 101 determines the abnormal region according to a light scattering level of the sensing image. For example, if the surface Sr is supposed to be flat, but the some sensing images show that light scattering levels of some regions are larger, the processing circuit 101 can determine the regions have larger light scattering levels as abnormal regions since the these region are uneven. The scattering level can be determined by various methods, for example, based on distributions of light regions in the sensing image.

In one embodiment, the automatic sweeper 100 comprises at least one light source configured to emit light with a predetermined light wave length. If the surface has an unexpected color, which may be caused by an unexpected object, an unexpected surface state (e.g., the surface Sr damages), or stains on the surface Sr, the wavelengths of the light may be changed, thus the image sensor IS may receive light with unexpected wave lengths. Therefore, the processing circuit 101 can determine the abnormal region according to a light wave length of light received by the image sensor IS.

In one embodiment, the processing circuit determines the abnormal region according to image features of the sensing image. As shown in FIG. 3, the continuous sensing image SI1 and SI2 both have unexpected image features IF and the processing circuit 101 determines the regions have the unexpected image features IF as abnormal regions. In one embodiment, the automatic sweeper 100 has the function of recording a map of a building in which the automatic sweeper 100 is provided. In such case, the automatic sweeper 100 can record image features corresponding to regions in the map. Therefore, if new image features such as the image features IF in FIG. 3 appear, the processing circuit 101 determines these new image features as unexpected image features. The image features may comprise shapes, textures or colors. The color mentioned here can be gray level or other colors such as RGB colors.

Based on the embodiment illustrated in FIG. 3, in one embodiment, the processing circuit 101 determines a plurality of candidate abnormal regions according to the image features, determines the candidate abnormal region which has repeated image features as a normal region, and determines the candidate abnormal region which does not have the repeated image features as the abnormal region. As shown in the embodiment of FIG. 4, the floor 400 comprises tiles and gaps between tiles, thus has repeated image features for different regions. Specifically, the floor 400 has repeated colors (while tiles and black gaps) for different regions.

In the embodiments, all regions of the floor 400 are determined as candidate abnormal regions since they have different colors. Also, the candidate abnormal regions CAR1, CAR2, CAR3 are determined as normal regions since they have repeated color variations (or have repeated colors). On the opposite, the candidate abnormal regions CAR4, CAR5 are determined as abnormal regions since they have non-repeated color variations (or have non-repeated colors).

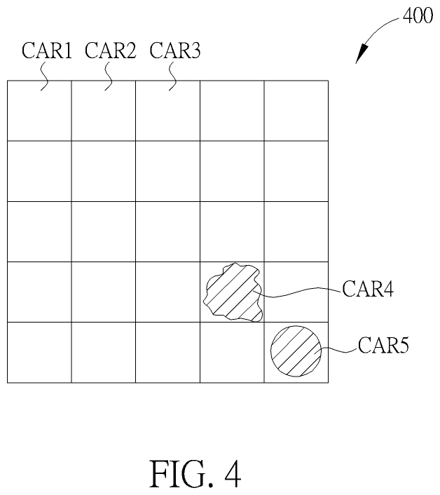

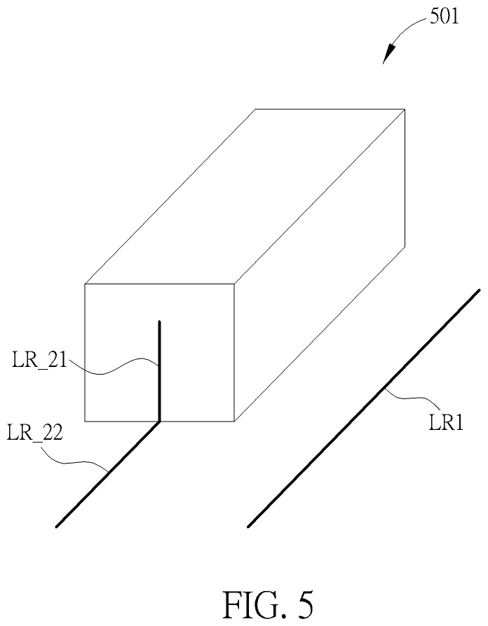

In another embodiment, the processing circuit 101 determines a protruding level of an object on a surface according to image features of the sensing image, and determines the abnormal region according to the protruding level. In the embodiment of FIG. 5, the automatic sweeper 100 further comprises a line light source to help determines the protruding level. Please note, the protruding level is not limited to mean a real height of the protruding object, it can only mean whether the object protrudes from the surface or not.

As illustrated in FIG. 5, if the line light is emitted to the surface having no protruding portion, a straight light region LR1 is formed. On the opposite, if the line light is emitted to an object 501 on the surface, a turning light region comprising the light regions LR_21, LR_22 is formed. Therefore, the processing circuit 101 can determine the protruding level according to the light region in the sensing image. In another embodiment, the automatic sweeper 100 does not have a line light source, but the processing circuit 101 can still determine the protruding level. For example, if the color greatly varies in a vertical direction of the sensing image, the processing circuit 101 can determine that an object protrudes from the surface.

In one embodiment, the automatic sweeper 100 has the function of recording a map of a building in which the automatic sweeper 100 is provided. In such case, the automatic sweeper 100 can record image features corresponding to regions in the map. Therefore, if new image features which vary greatly in the vertical direction appear, the processing circuit 101 can determine the object protrudes from the surface according to these new image features.

After determine the protruding levels for varies regions, the automatic sweeper 100 can determine and record the regions which protrude from the surface. FIG. 6 is a schematic diagram illustrating a sensing image comprising regions which protrude from a surface. As illustrated in FIG. 6, the regions marked by slashes mean objects protrude from the surface. After determine the regions which protrude from the surface, the processing circuit 101 can directly determine these regions as abnormal regions. Alternatively, in one embodiment, after determine the regions which protrude from the surface, the processing circuit 101 does not directly determine these regions as abnormal regions, and further steps are provided for determining the abnormal regions. Such embodiment will be described for more detail later.

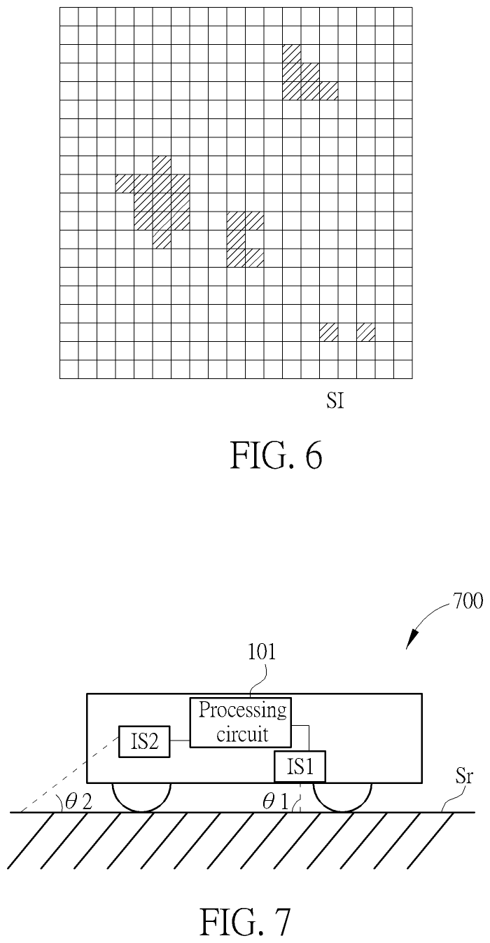

FIG. 7 is a schematic diagram illustrating an automatic sweeper according to another embodiment of the present invention. As shown in FIG. 7, the automatic sweeper 700 comprises a processing circuit 101, a first image sensor IS1 and a second image sensor IS2. The first image sensor IS1 is configured to generate first sensing images. A first angle θ1 exists between a sensing direction (the dotted line) of a sensing surface of the first image sensor IS1 and the surface Sr. The first angle θ1 is a smallest angle among angles exist between the sensing direction of the first image sensor IS1 and the surface Sr.

The second image sensor IS2 is configured to generate second sensing images. The second angle θ2 exists between a sensing direction of a sensing surface of the second image sensor IS2 and the surface Sr. The second angle θ2 is a smallest angle among angles exist between the sensing direction of the second image sensor IS2 and the surface Sr, wherein the first angle θ1 is larger than the second angle θ2. In other words, the sensing direction (the dotted line) of the first image sensor is lower, and the sensing direction of the second image sensor IS2 is more forward. The processing circuit 101 is configured to determine and record at least one abnormal region according to the second sensing images of the second image sensor and then according to the first sensing images.

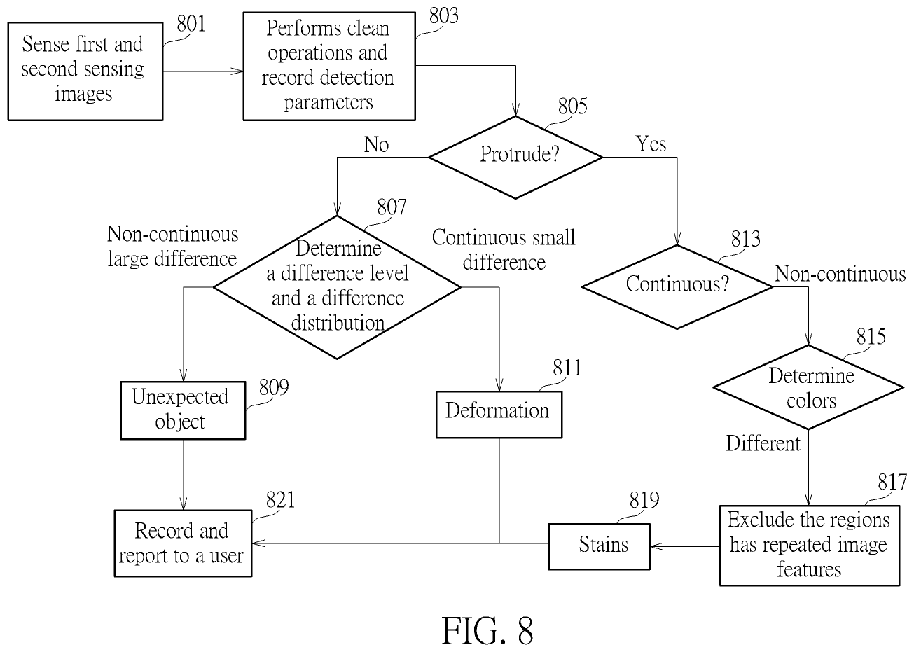

FIG. 8 is a flow chart illustrating detail operations of the automatic sweeper according to one embodiment of the present invention. FIG. 8 uses automatic sweeper 700 illustrated in FIG. 7. However, please note, the steps in FIG. 8 can also be performed by an automatic sweeper comprising only one image sensor, such as the automatic sweeper 100 illustrated in FIG. 1. Further, in FIG. 8, the determination can be made according to only one sensing image or according to a plurality of continuous sensing images. FIG. 8 comprises following steps

### Step 801

Use the first image sensor IS1 to sense first sensing images and the second image sensor IS2 to sense second sensing images. As above-mentioned, in one embodiment, the automatic sweeper 700 comprises light sources to assist this step.

### Step 803

The automatic sweeper 700 performs clean operations and record detection parameters such as the above-mentioned image features.

### Step 805

The processing circuit 101 determines whether the object protrudes or not (i.e., whether the protruding level is larger than a protruding threshold or not) according to the second sensing image from the second image sensor IS2. If yes, go to step 807, if not, go to step 815.

Also, in following steps 807-811, the processing circuit 101 further determines a type of the abnormal region according to a difference level and a difference distribution of light intensities of reflected light received by the second image sensor IS2.

### Step 807

Determine a difference level and a difference distribution of light intensities of reflected light received by the second image sensor IS2. That is, determine a difference level and a difference distribution of the light regions in the second sensing image.

If the light intensities non-continuously vary and the difference level is larger than a difference threshold, go to step 809. Also, if the light intensities continuously vary and the difference level is smaller than a difference threshold, go to step 811.

### Step 809

Determine the abnormal region is an unexpected object, such as a coin, a plastic bag, a plastic piece, a toy or a block. In other words, if the light intensities non-continuously vary and greatly varies, it means an un-expected object may exist on the surface.

### Step 811

Determine the abnormal region is deformation of the surface. For example, if the floor damages, protrudes or splits, these deformation regions may causes the light intensities to continuously vary and the difference level is smaller since the deformation regions may have larger areas.

The following steps 813, 815, 817, are performed according to the first sensing image generated by the first image sensor and are similar with the operations illustrated in FIG. 4.

### Step 813

The processing circuit 101 determines if image features of the first sensing image of the first image sensor IS1 are continuous. For example, the processing circuit 101 determines if shadows in the sensing image are continuous. If non-continuous, go to step 815. Also, if continuous, the process can go back to the step 805 for a next sensing image.

### Step 815

Determine colors of neighboring regions in at least one sensing image are identical or not. If the colors are identical, the process can go back to the step 805 for a next sensing image. If the colors are not identical, the process goes to the step 817.

### Step 817

Exclude the regions has repeated image features (or named regular image feature variations). For example, in FIG. 4, the candidate abnormal regions CAR1, CAR2 and CAR3 are determined as normal regions, and the candidate abnormal regions CAR4, and CAR5 are determined as abnormal regions.

### Step 819

Determine the abnormal regions as stains, such as the abnormal regions CAR4, and CAR5 in FIG. 4.

The stains may be caused by various factors, such as drinks, inks, any liquid with colors, or dirt.

### Step 821

Record the locations and/or the types of the abnormal regions, and report to a user.

Besides reporting to the user, the automatic sweepers 100 and 700 can perform other operations corresponding to the abnormal region. For example, the automatic sweepers 100 and 700 can stop and generate warning message, and waits for the user to process. In such case, the abnormal region is not recorded. By this way, the automatic sweepers 100 and 700 can avoid cleaning wrong regions or inhaling small objects which may damage the automatic sweepers.

In the process of FIG. 8, the processing circuit 101 determines types of the abnormal region according to difference levels, difference distributions or colors. However, in other embodiments, the processing circuit 101 can further determine types by other methods. For example, the processing circuit 101 can determine the type of the abnormal region is hair by shapes in the sensing image.

It will be appreciated that although above-mentioned embodiments are used to automatic sweepers, the above-mentioned embodiments can be applied to any other optical navigation device such as an optical mouse. Also, any combination or variation based on the above-mentioned embodiments should also fall in the scope of the present invention.

The above-mentioned embodiments can be applied to a robot cleaner. Therefore, the above embodiment can be summarized as: a robot, comprising: a housing (e.g., 103 in FIG. 1), having at least two wheels (e.g., W1 and W2 in FIG. 1) and configured to move on a working surface (e.g., Sr in FIG. 1); at least one image sensor (e.g., IS in FIG. 1), disposed in the housing and configured to sense at least one sensing image; and a processing circuit (e.g., 101 in FIG. 1), disposed in the housing and configured to determine at least one abnormal region in the sensing image and control the robot to inform a user with the abnormal region.

In view of above-mentioned embodiments, the automatic sweeper can detect abnormal regions, thus the user does not need to check the state of the floor under furniture by his self. Besides, the automatic sweeper can avoid to be damaged due to the unexpected objects on the floor.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical navigation device, comprising:
at least one image sensor, configured to sense at least one sensing image; and
a processing circuit, configured to determine at least one abnormal region in the sensing image and control the optical navigation device to inform the abnormal region exists to a user.

2. The optical navigation device of claim 1, wherein the processing circuit determines the abnormal region according to a light scattering level of the sensing image.

3. The optical navigation device of claim 1, wherein the processing circuit determines the abnormal region according to image features of the sensing image.

4. The optical navigation device of claim 3, wherein the processing circuit determines a plurality of candidate abnormal regions according to the image features, determines the candidate abnormal region which has repeated image features as a normal region, and determines the candidate abnormal region which does not have the repeated image features as the abnormal region.

5. The optical navigation device of claim 4, wherein the image features comprises colors.

6. The optical navigation device of claim 1, wherein the processing circuit determines a protruding level of an object on a surface according to image features of the sensing image, and determines the abnormal region according to the protruding level.

7. The optical navigation device of claim 6, wherein the processing circuit further determines a type of the abnormal region according to a difference level and a difference distribution of light intensities of reflected light received by the image sensor.

8. The optical navigation device of claim 7, wherein the processing circuit further determines the abnormal region is an unexpected object if the light intensities non-continuously vary and the difference level is larger than a difference threshold.

9. The optical navigation device of claim 7, wherein the processing circuit further determines the abnormal region is deformation of the surface if the light intensities continuously vary and the difference level is smaller than a difference threshold.

10. The optical navigation device of claim 6,
wherein the processing circuit further determines if image features of the sensing image are continuous when the protruding level is lower than a protruding threshold;
wherein the processing circuit further determines colors of the sensing images if the image features are non-continuous and determines the abnormal region according to the colors.

11. The optical navigation device of claim 10, wherein the optical navigation device comprises:
a first image sensor, configured to generate first sensing images, wherein a first angle exists between a sensing direction of a sensing surface of the first image sensor and the surface, wherein the first angle is a smallest angle among angles exist between the sensing direction of the first image sensor and the surface; and
a second image sensor, configured to generate second sensing images, wherein a second angle exists between a sensing direction of a sensing surface of the second image sensor and the surface, wherein the second angle is a smallest angle among angles exist between the sensing direction of the second image sensor and the surface, wherein the first angle is larger than the second angle;
wherein the processing circuit determines the protruding level according to the second sensing images;
wherein the processing circuit determines if the image features of the sensing image of the first image sensor are continuous, and determines the colors according to the image features of the first sensing images.

12. The optical navigation device of claim 1, further comprising:
at least one light source, configured to emit light with a predetermined light wave length;
wherein the processing circuit determines the abnormal region according to a light wave length of light received by the image sensor.

13. An optical navigation device, comprising:
a first image sensor, configured to generate first sensing images, wherein a first angle exists between a sensing direction of a sensing surface of the first image sensor and the surface, wherein the first angle is a smallest angle among angles exist between the sensing direction of the first image sensor and the surface;
a second image sensor, configured to generate second sensing images, wherein a second angle exists between a sensing direction of a sensing surface of the second image sensor and the surface, wherein the second angle is a smallest angle among angles exist between the sensing direction of the second image sensor and the surface, wherein the first angle is larger than the second angle; and
a processing circuit, configured to determine and record at least one abnormal region according to the second sensing images of and then according to the first sensing images.

14. The optical navigation device of claim 13, wherein the processing circuit determines a protruding level of an object on a surface according to image features of the second sensing image, and determines the abnormal region according to the protruding level.

15. The optical navigation device of claim 14, wherein the processing circuit further determines a type of the abnormal region according to a difference level and a difference distribution of light intensities of reflected light received by the second image sensor.

16. The optical navigation device of claim 15, wherein the processing circuit further determines the abnormal region is an unexpected object if the light intensities non-continuously vary and the difference level is larger than a difference threshold.

17. The optical navigation device of claim 15, wherein the processing circuit further determines the abnormal region is deformation of the surface if the light intensities continuously vary and the difference level is smaller than a difference threshold.

18. A robot, comprising:
a housing, having at least two wheels and configured to move on a working surface;
at least one image sensor, disposed in the housing and configured to sense at least one sensing image; and
a processing circuit, disposed in the housing and configured to determine at least one abnormal region in the sensing image and control the robot to inform a user with the abnormal region.
